(19) United States
(12) Patent Application Publication
(10) Pub. No.: US 2025/0192342 A1
(43) Pub. Date: Jun. 12, 2025

(54) THERMAL MANAGEMENT VALVES FOR CONTROLLING BATTERY CELL VENT BYPRODUCTS WITHIN TRACTION BATTERY PACKS

(71) Applicant: FORD GLOBAL TECHNOLOGIES, LLC, Dearborn, MI (US)

(72) Inventors: Patrick Roxin, Livonia, MI (US); Mohammadreza Eftekhari, Novi, MI (US); Kanchana Perumalla, Troy, MI (US); Bhaskara Rao Boddakayala, Troy, MI (US); Sara Buchel, Fenton, MI (US); William Lee Hom, Royal Oak, MI (US)

(21) Appl. No.: 18/742,468

(22) Filed: Jun. 13, 2024

Related U.S. Application Data
(60) Provisional application No. 63/607,888, filed on Dec. 8, 2023.

(51) Int. Cl. H01M 50/342; B60L 50/64; H01M 10/0525; H01M 10/658; H01M 50/211; H01M 50/227

(52) U.S. Cl. CPC H01M 50/3425; B60L 50/64; H01M 10/0525; H01M 10/658; H01M 50/211; H01M 50/227; H01M 2220/20

(57) ABSTRACT

Thermal management valve assemblies are provided for use within traction battery packs. An exemplary thermal management valve assembly may be configured to block the transfer of thermal energy to adjacent structures inside the traction battery pack during normal operating conditions and may be further configured to control the flow of battery cell vent byproducts during battery thermal events. The thermal management valve assembly may include one or more attachment frames that can be mounted to a cell stack cross-member assembly, and one or more thermal barriers that can be connected to the attachment frame(s).

### CROSS-REFERENCE TO RELATED APPLICATIONS

This disclosure claims priority to U.S. Provisional Application No. 63/607,888, which was filed on Dec. 8, 2023 and is incorporated herein by reference in its entirety.

### TECHNICAL FIELD

This disclosure relates generally to traction battery packs, and more particularly to thermal management valves for controlling the flow of battery cell vent byproducts within traction battery packs.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a cell stack including a plurality of battery cells arranged between a first cross-member assembly and a second cross-member assembly. The first cross-member assembly and the second cross-member assembly each include a ladder frame and a thermal management valve assembly mounted to the ladder frame.

In a further non-limiting embodiment of the foregoing traction battery pack, the ladder frame is made of a thermoplastic material and includes a plurality of cell tab openings each sized to receive a terminal of one or more of the plurality of battery cells.

In a further non-limiting embodiment of either of the foregoing traction battery packs, the ladder frame includes a vent opening.

In a further non-limiting embodiment of any of the foregoing traction battery packs, the thermal management valve assembly includes a thermal barrier that is pivotable between a first position that covers the vent opening and a second position that uncovers the vent opening in response to a flow of a battery cell vent byproduct against the thermal barrier.

In a further non-limiting embodiment of any of the foregoing traction battery packs, the thermal management valve assembly includes a thermal barrier having a perforated section that is configured to rupture in response to a flow of a battery cell vent byproduct against the thermal barrier.

In a further non-limiting embodiment of any of the foregoing traction battery packs, the perforated section is rectangular shaped.

In a further non-limiting embodiment of any of the foregoing traction battery packs, the perforated section is X-shaped.

In a further non-limiting embodiment of any of the foregoing traction battery packs, the thermal management valve assembly includes an upper attachment frame that is mounted to the ladder frame, a lower attachment frame that is mounted to the ladder frame, and a thermal barrier that extends between the upper attachment frame and the lower attachment frame.

In a further non-limiting embodiment of any of the foregoing traction battery packs, the upper attachment frame and the lower attachment frame are clipped to the ladder frame.

In a further non-limiting embodiment of any of the foregoing traction battery packs, a first pushpin mounts the thermal barrier to the upper attachment frame, and a second pushpin mounts the thermal barrier to the lower attachment frame.

In a further non-limiting embodiment of any of the foregoing traction battery packs, a sealing frame is received against a backside of the thermal barrier and is arranged to seal a seam between the thermal barrier and a second thermal barrier of the thermal management valve assembly.

In a further non-limiting embodiment of any of the foregoing traction battery packs, the ladder frame includes an integrally formed fastener housing. A fastener insert is received within the integrally formed fastener housing.

In a further non-limiting embodiment of any of the foregoing traction battery packs, a pultruded reinforcement beam is attached to the ladder frame.

A traction battery pack according to another exemplary aspect of the present disclosure includes, among other things, a cross-member assembly, and a thermal management valve assembly mounted to the cross-member assembly and including an upper attachment frame, a lower attachment frame, and a plurality of thermal barriers that extend between the upper attachment frame and the lower attachment frame.

In a further non-limiting embodiment of the foregoing traction battery pack, the cross-member assembly includes a ladder frame, a first reinforcement beam that establishes a first pultrusion of the cross-member assembly, and a second reinforcement beam that establishes a second pultrusion of the cross-member assembly.

In a further non-limiting embodiment of the foregoing traction battery pack, the upper attachment frame is mounted at an upper section of the ladder frame, and the lower attachment frame is mounted at a lower section of the ladder frame.

In a further non-limiting embodiment of either of the foregoing traction battery packs, a first thermal barrier of the plurality of thermal barriers is pivotable between a first position that covers a vent opening of the ladder frame and a second position that at least partially uncovers the vent opening in response to a flow of a battery cell vent byproduct against the first thermal barrier.

In a further non-limiting embodiment of any of the foregoing traction battery packs, a first thermal barrier of the thermal management valve assembly includes a perforated section that is configured to rupture in response to a flow of a battery cell vent byproduct against the first thermal barrier.

In a further non-limiting embodiment of any of the foregoing traction battery packs, a first pushpin mounts a first thermal barrier of the plurality of thermal barriers to the upper attachment frame, and a second pushpin mounts the first thermal barrier to the lower attachment frame.

In a further non-limiting embodiment of any of the foregoing traction battery packs, the thermal management valve assembly includes a sealing frame that is arranged to seal a seam between a first thermal barrier and a second thermal barrier of the plurality of thermal barriers.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 is a perspective view of a cell stack of the traction battery pack of FIG. 2.

FIG. 4 illustrates a thermal management valve assembly for controlling the flow of battery cell vent byproducts within a traction battery pack.

FIG. 5 schematically illustrates the thermal management valve assembly of FIG. 4 during normal battery operating conditions.

FIG. 6 schematically illustrates the thermal management valve assembly of FIG. 4 during a battery thermal event.

FIG. 7 illustrates another exemplary thermal management valve assembly.

FIG. 8 illustrates another exemplary thermal management valve assembly.

FIG. 9 illustrates another exemplary thermal management valve assembly.

FIG. 10 illustrates yet another exemplary thermal management valve assembly.

FIG. 11 illustrates the thermal management valve assembly of FIG. 10 attached relative to a cross-member assembly of a cell stack.

FIG. 12 illustrates yet another exemplary thermal management valve assembly.

### DETAILED DESCRIPTION

This disclosure details thermal management valve assemblies for use within traction battery packs. An exemplary thermal management valve assembly may be configured to block the transfer of thermal energy to adjacent structures inside the traction battery pack during normal operating conditions and may be further configured to control the flow of battery cell vent byproducts during battery thermal events. The thermal management valve assembly may include one or more attachment frames that can be mounted to a cell stack cross-member assembly, and one or more thermal barriers that can be connected to the attachment frame(s). These and other features are discussed in greater detail in the following paragraphs of this detailed description.

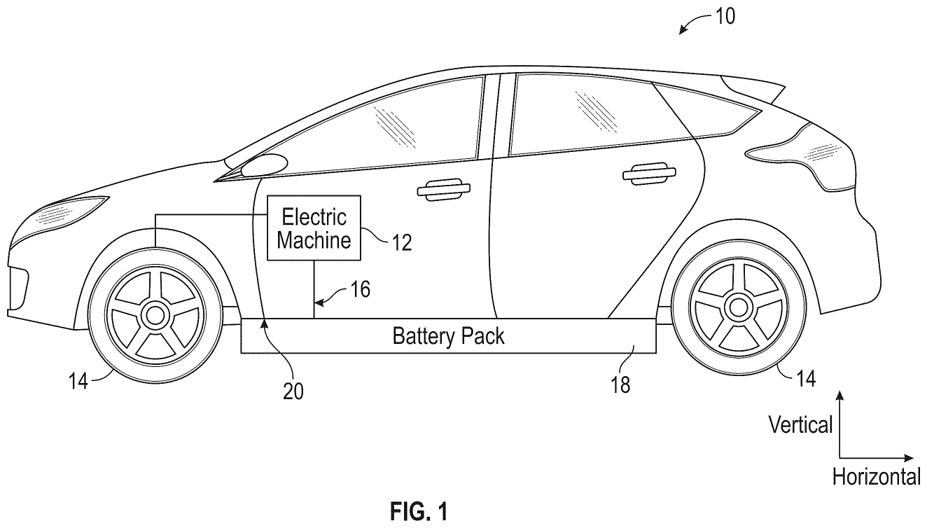

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

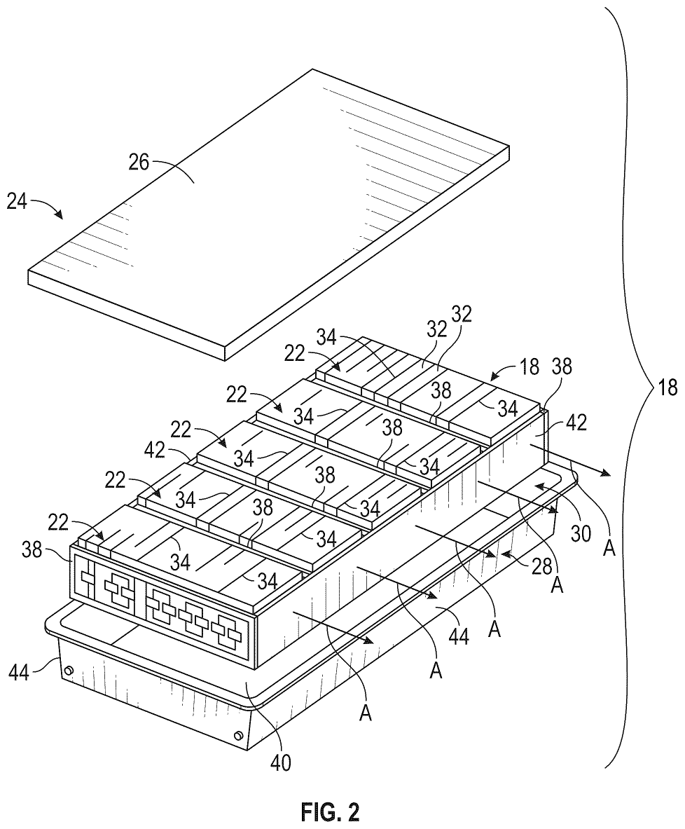

FIG. 2 illustrates additional details associated with the traction battery pack 18 of the electrified vehicle 10 of FIG. 1. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cell stacks 22 and other battery internal components of the traction battery pack 18.

Each cell stack 22 may include a plurality of battery cells 32. The battery cells 32 of each cell stack 22 may be stacked together and arranged along a cell stack axis A. The battery cells 32 store and supply electrical power for powering various components of the electrified vehicle 10. Although a specific number of cell stacks 22 and battery cells 32 are illustrated in the various figures of this disclosure, the traction battery pack 18 could include any number of the cell stacks 22, with each cell stack 22 including any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The battery cells 32 can each include tab terminals that project outwardly from a battery cell housing. The tab terminals of the battery cells 32 of each cell stack 22 are connected to one another, such as by one or more busbars, for example, in order to provide the voltage and power levels necessary for achieving electric vehicle propulsion.

One or more thermal barrier assemblies 34 may be arranged along the respective cell stack axis A of each cell stack 22. The thermal barrier assemblies 34 may compartmentalize each cell stack 22 into two or more groupings or compartments of battery cells 32. Each compartment may hold one or more of the battery cells 32 of the cell stack 22.

The battery cells 32 of each cell stack 22 may be arranged between a pair of cross-member assemblies 38. Among other functions, the cross-member assemblies 38 may be configured to hold the battery cells 32 and at least partially delineate the cell stacks 22 from one another within the interior area 30 of the enclosure assembly 24.

Each cross-member assembly 38 may be configured to transfer a load applied to a side of the electrified vehicle 10, for example, for ensuring that the battery cells 32 do not become overcompressed. Each cross-member assembly 38 may be further configured to accommodate tension loads resulting from expansion and retraction of the battery cells 32. The cross-member assemblies 38 described herein are therefore configured to increase the structural integrity of the traction battery pack 18.

A vertically upper side of each cell stack 22 may interface with the enclosure cover 26, and a vertically lower side of each cell stack 22 may interface with a heat exchanger plate 40 that is positioned against a floor of the enclosure tray 28. In another embodiment, the heat exchanger plate 40 may be omitted and the vertically lower side of each cell stack 22 may be received in direct contact with the floor of the enclosure tray 28. Vertical and horizontal, for purposes of this disclosure, are with reference to ground and a general orientation of traction battery pack 18 when installed on the electrified vehicle 10 of FIG. 1.

The cross-member assemblies 38 may be adhesively secured to the enclosure cover 26 and to either the heat exchanger plate 40 or the enclosure tray 28 to seal the interfaces between these neighboring components and to structurally integrate the traction battery pack 18.

Each cell stack 22 may be arranged to extend along its respective cell stack axis A between opposing end plates 42. One or more end plates 42 may be positioned between the end of each cell stack 22 and a longitudinally extending side wall 44 of the enclosure tray 28. The end plates 42 may therefore extend along axes that are substantially transverse (e.g. perpendicular) to the cell stack axes A of the cell stacks 22 and the cross-member assemblies 38. In some implementations, the end plates 42 are structural members that span across a majority of the length of the longitudinally extending side wall 44 of the enclosure tray 28. However, other configurations are contemplated within the scope of this disclosure.

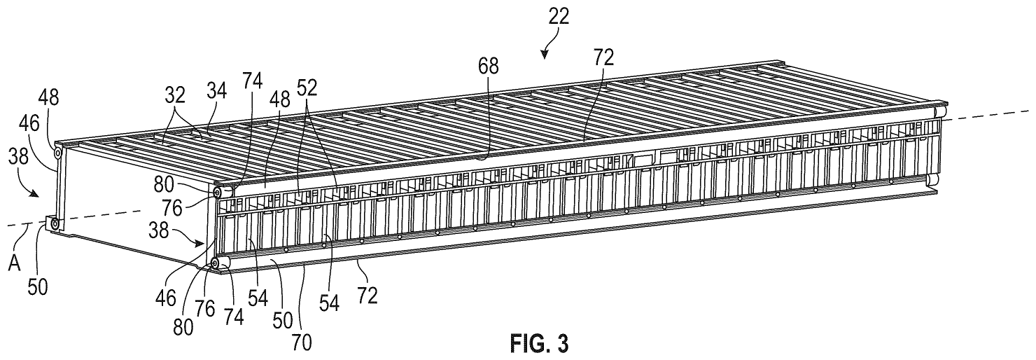

Referring now to FIG. 3, the cross-member assemblies 38 of each cell stack 22 may include a ladder frame 46 and one or more reinforcement sections. In the illustrated embodiment, the cross-member assembly 38 includes an upper or first reinforcement beam 48 and a lower or second reinforcement beam 50. However, other configurations are also contemplated within the scope of this disclosure.

The ladder frame 46 may be either a unitary or multi-piece injection molded structure. The ladder frame 46 may be made of any suitable thermoplastic material.

The ladder frame 46 may include one or more vent openings 52 for communicating battery cell vent byproducts released by one or more battery cells 32 through the ladder frame 46 and into a passageway located between adjacent cell stacks 22. The vent openings 52 may therefore provide a pathway for battery cell vent byproducts to move through the cross-member assembly 38 as may be required during a cell venting event of one or more of the battery cell 32 of the cell stack 22, for example.

The ladder frame 46 may additionally include a plurality of cell tab openings 54 arranged vertically below the vent openings 52. The cell tab openings 54 may be configured as elongated slots that are sized to accommodate cell tab terminals of the battery cells 32. In an embodiment, each cell tab opening 54 may accommodate one cell tab terminal. In another embodiment, each cell tab opening 54 may be sized to receive cell tab terminals from multiple adjacent battery cells 32 of the cell stack 22.

In an assembled state of the cross-member assembly 38, both the vent openings 52 and the cell tab openings 54 are located between the first and second reinforcement beams 48, 50. However, other configurations could be possible within the scope of this disclosure.

The first reinforcement beam 48 and the second reinforcement beam 50 may be mounted at separate locations of the ladder frame 46 for structurally reinforcing the cross-member assembly 38. The ladder frame 46 and the first and second reinforcement beams 48, 50 may include mateable features that facilitate the connection of the first and second reinforcement beams 48, 50 to the ladder frame 46. For example, the ladder frame 46 may include first engagement features that are configured to mesh with or interdigitate with a second engagement feature of the first reinforcement beam 48 or the second reinforcement beam 50. In an embodiment, the first engagement features each include a first arrangement of fingers and slots, and the second engagement features each include a second arrangement of fingers and slots. The fingers of the first engagement features can be received in the slots of the second engagement features and vice versa in order to mount the first and second reinforcement beams 48, 50 to the ladder frame 46. Although not shown, an adhesive could be applied between the first and second engagement features for further facilitating the connection of the first and second reinforcement beams 48, 50 to the ladder frame 46.

In an embodiment, the first and second reinforcement beams 48, 50 are pultrusions, which implicates structure to these beam-like structures. A person of ordinary skill in the art having the benefit of this disclosure would understand how to structurally distinguish a pultruded beam structure from another type of structure, such as an extruded beam, for example.

The first and second reinforcement beams 48, 50 may be manufactured as part of a pultrusion process that utilizes a glass or carbon fiber (unidirectional or multidirectional mat) and a thermoset resin. A plurality of glass or carbon fiber strands may be pulled through the thermoset resin as part of the pultrusion process for manufacturing the first and second reinforcement beams 48, 50.

When mounted to the ladder frame 46, the first reinforcement beam 48 may establish an upper plateau 68 of the cross-member assembly 38, and the second reinforcement beam 50 may establish a lower base 70 of the cross-member assembly 38. An adhesive 72 may be applied to the upper plateau 68 and to the lower base 70 for securing the cross-member assembly 38 directly to the enclosure cover 26 and to either the heat exchanger plate 40 or the enclosure tray 28, respectively. Each cell stack 22 may therefore be structurally integrated with the enclosure assembly 24 of the traction battery pack 18 via the cross-member assemblies 38.

Each end of the ladder frame 46 may include one or more fastener housings 74 that are each sized to receive a fastener insert 76. Each fastener insert 76 may be made of a thermoset material, for example, and may be received within an opening provided by the fastener housing 74. In an embodiment, the fastener housings 74 are integrally formed (e.g., molded) features of the ladder frame 46. The first reinforcement beam 48 and the second reinforcement beam 50 may be appropriately shaped to accommodate the fastener housings 74.

Each fastener insert 76 may include a fastener opening 80 that is configured to receive a fastener (e.g., a bolt or screw, not shown) for mounting the cross-member assembly 38 and thus an associated cell stack 22 to a neighboring structure, such as one of the end plates 42, for example. The fastener may be passed through the end plate 42 and can then be accommodated within the fastener opening 80 of the fastener insert 76 for mounting the cell stack 22 to the end plate 42. This connection can help contain tensile loads that can occur over the life of the cell stack 22 as a result of battery cell expansion forces, for example.

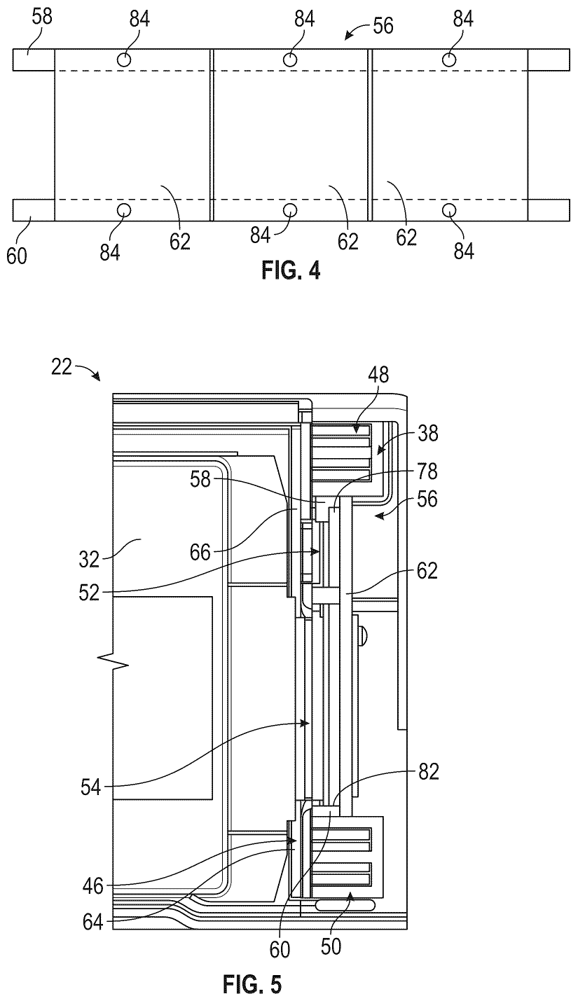

FIGS. 4, 5, and 6 illustrate an exemplary thermal management valve assembly 56 that can be mounted to each of the cross-member assemblies 38 of the cells stacks 22 shown in FIGS. 2 and 3. The thermal management valve assembly 56 may include an upper attachment frame 58, a lower attachment frame 60, and a plurality of thermal barriers 62.

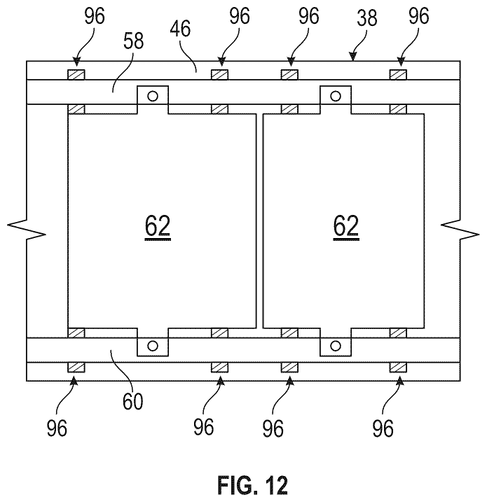

The upper attachment frame 58 and the lower attachment frame 60 may cooperate to mount the thermal management valve assembly 56 to the ladder frame 46 of the cross-member assembly 38. For example, the upper attachment frame 58 may be clipped onto an upper section 66 of the ladder frame 46, and the lower attachment frame 60 may then be moved (e.g., rotated) into position relative to a lower section 64 of the ladder frame 46 for detachably mounting the thermal management valve assembly 56 to the cross-member assembly 38. In the mounted position (see FIG. 5), the upper attachment frame 58 clips onto a tab 78 of the upper section 66, and the lower attachment frame 60 abuts against a shelf 82 of the lower section 64. However, the upper attachment frame 58 and the lower attachment frame 60 could alternatively or additionally be secured to the ladder frame 46 by an adhesive and/or some other fastener within the scope of this disclosure. For example, the ladder frame 46 may include integrally formed clips 96 (see, e.g., FIG. 12) that are configured to allow the upper attachment frame 58 and the lower attachment frame 60 to be snap-connected to the ladder frame 46.

The upper section 66 of the ladder frame 46 may be vertically above the lower section 64. In an embodiment, the lower section 64 and the upper section 66 extend on opposite sides of the cell tab openings 54 of the ladder frame 46.

Each thermal barrier 62 of the thermal management valve assembly 56 may be attached to both the upper attachment frame 58 and the lower attachment frame 60 by one or more pushpins 84. In the mounted position (see FIG. 5), the thermal barriers 62 are arranged to substantially cover the cell tab openings 54 and the vent openings 52 of the ladder frame 46. The thermal barriers 62 are configured for limiting the transfer of thermal energy from the cell stack 22 to a neighboring structure, such as another cell stack, for example, thereby limiting battery cell vent byproducts and their associated heat from influencing the structural integrity of the traction battery pack 18 during battery thermal events.

In an embodiment, the thermally barriers 62 are mica sheets. However, the thermal barriers 62 could be made of aerogel materials, refractory ceramic fibers, or other materials or combinations of materials that are capable of providing flame resistant and heat insulation properties.

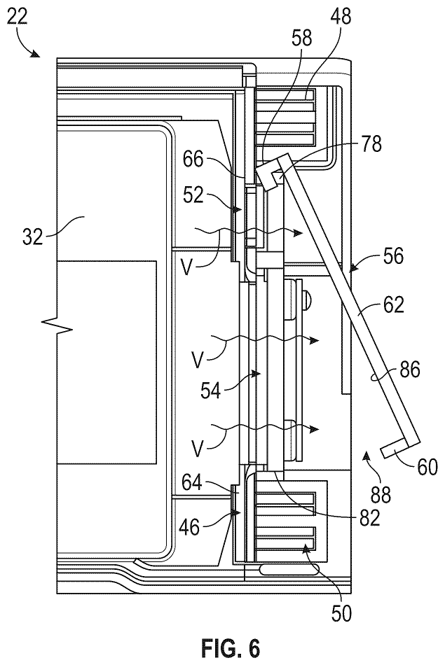

FIG. 5 and FIG. 6 illustrate the thermal management valve assembly 56 during normal operating conditions of the traction battery pack 18 and during a battery thermal event, respectively. During normal operating conditions of the traction battery pack 18 such as schematically shown in FIG. 5, the thermal barriers 62 are positioned to substantially cover the vent openings 52 and the cell tab openings 54 of the ladder frame 46. The thermal barriers 62 are therefore configured to block the transfer of thermal energy from the cell stack 22 to an adjacent cell stack or other battery internal structure of the traction battery pack 18.

During a battery thermal event such as schematically shown in FIG. 6, one or more of the battery cells 32 of the cell stack 22 can rupture and release battery cell vent byproducts V. Although a single one of the battery cells 32 is shown as venting in FIG. 6, more than one of the battery cells 32 of the cell stack 22 can vent at the same time. The battery cell vent byproducts V may flow through one or more vent openings 52 and/or cell tab openings 54 and then against one or more of the thermal barriers 62 of the thermal management valve assembly 56. The battery cell vent byproducts V can move against a backside 86 of one or more of the thermal barriers 62 during the battery thermal event, thereby forcing the lower attachment frame 60 to pivot outwardly away from the cross-member assembly 38 and permit flow of the battery cell vent byproducts V through an exposed opening 88 of the thermal management valve assembly 56. The backside 86 of each thermal barrier 62 faces toward the battery cells 32 of the cell stack 22.

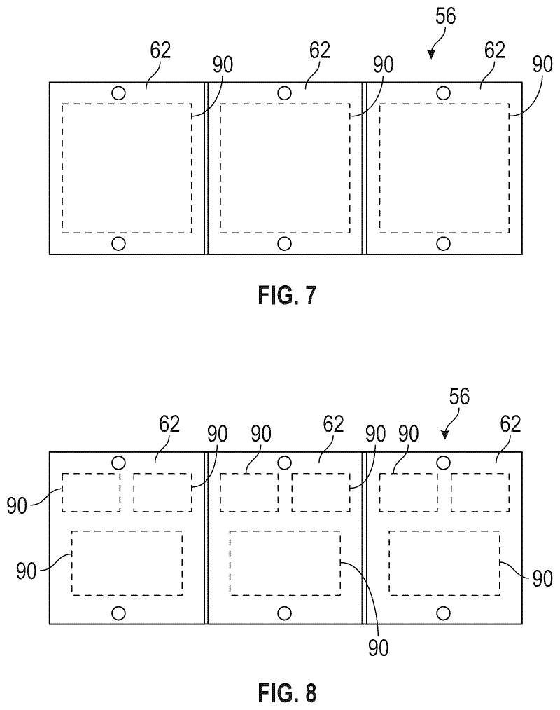

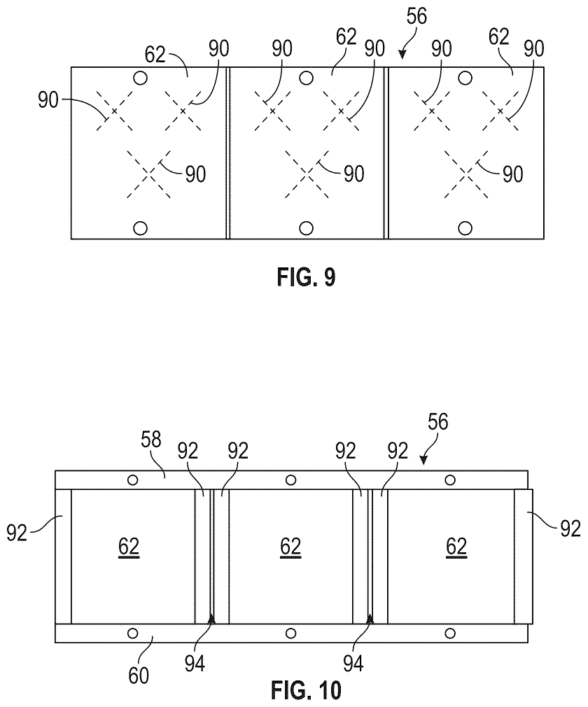

In the alternative embodiments shown in FIGS. 7, 8, and 9, the thermal barriers 62 of the thermal management valve assembly 56 may each include one (see FIG. 7) or more (see FIGS. 8 and 9) perforated sections 90 that are configured to establish weakened spots within the thermal barriers 62. The perforated sections 90 may be rectangular shaped (see FIGS. 7 and 8), X-shaped (see FIG. 9), or could embody any other suitable shapes. The perforated sections 90 may further be sized and positioned to cover the vent openings 52, the cell tab openings 54, or both. The perforated section(s) 90 that is located directly outward of the vent openings 52 and/or the cell tab openings 54 when the thermal management valve assembly 56 is mounted to the cross-member assembly 38 may locally break away from the thermal barrier(s) 62 or otherwise rupture to allow the battery cell vent byproducts V to pass through the thermal barrier(s) 62 during a battery thermal event. The portions of the thermal barrier(s) 62 that do not rupture remain in place to protect the battery cells 32 of the cell stack 22 from exposure to the battery cell vent byproducts V as the battery cell vent byproducts V flow along a gas exit path to a location away from the cell stack 22.

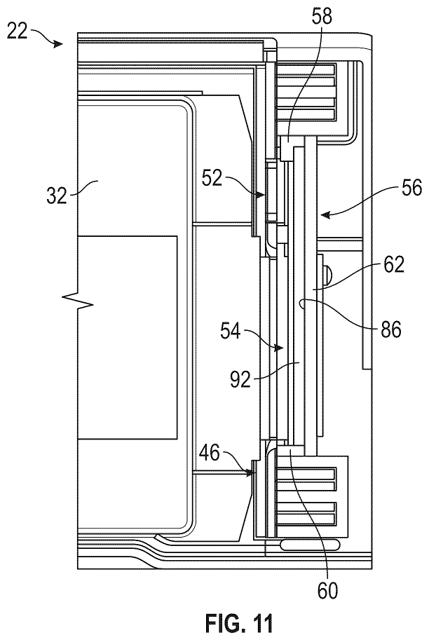

Referring now to FIGS. 10 and 11, the thermal management valve assembly 56 may additionally include a plurality of sealing frames 92. In an embodiment, one sealing frame 92 may be provided for each thermal barrier 62 of the thermal management valve assembly 56. Each sealing frame 92 may be arranged into direct contact with the backside 86 of the thermal barrier 62. The sealing frames 92 may be attached relative to the thermal barriers 62 and relative to the upper attachment frame 58 and the lower attachment frame 60 in any manner.

Each sealing frame 92 may be configured to seal a seam 94 that extends between adjacent sets of thermal barriers 62 of the thermal management valve assembly 56. The sealing frames 92 are therefore arranged to limit battery cell vent byproducts V from propagating from cell packet-to-cell packet across the cell stack 22 during battery thermal events. In an embodiment, each sealing frame 92 is made of a foam material. However, other materials are contemplated within the scope of this disclosure.

The exemplary cross-member assemblies of this disclosure include thermal management valve assemblies for blocking the transfer of thermal energy from cell stack-to-cell stack within a traction battery pack. The thermal management valve assemblies may further control the flow of battery cell vent byproducts during battery thermal events.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a cell stack including a plurality of battery cells arranged between a first cross-member assembly and a second cross-member assembly; and
the first cross-member assembly and the second cross-member assembly each including a ladder frame and a thermal management valve assembly mounted to the ladder frame.

2. The traction battery pack as recited in claim 1, wherein the ladder frame is comprised of a thermoplastic material and includes a plurality of cell tab openings each sized to receive a terminal of one or more of the plurality of battery cells.

3. The traction battery pack as recited in claim 1, wherein the ladder frame includes a vent opening.

4. The traction battery pack as recited in claim 3, wherein the thermal management valve assembly includes a thermal barrier that is pivotable between a first position that covers the vent opening and a second position that uncovers the vent opening in response to a flow of a battery cell vent byproduct against the thermal barrier.

5. The traction battery pack as recited in claim 3, wherein the thermal management valve assembly includes a thermal barrier having a perforated section that is configured to rupture in response to a flow of a battery cell vent byproduct against the thermal barrier.

6. The traction battery pack as recited in claim 5, wherein the perforated section is rectangular shaped.

7. The traction battery pack as recited in claim 5, wherein the perforated section is X-shaped.

8. The traction battery pack as recited in claim 1, wherein the thermal management valve assembly includes an upper attachment frame that is mounted to the ladder frame, a lower attachment frame that is mounted to the ladder frame, and a thermal barrier that extends between the upper attachment frame and the lower attachment frame.

9. The traction battery pack as recited in claim 8, wherein the upper attachment frame and the lower attachment frame are clipped to the ladder frame.

10. The traction battery pack as recited in claim 8, comprising a first pushpin that mounts the thermal barrier to the upper attachment frame, and a second pushpin that mounts the thermal barrier to the lower attachment frame.

11. The traction battery pack as recited in claim 8, comprising a sealing frame that is received against a backside of the thermal barrier and is arranged to seal a seam between the thermal barrier and a second thermal barrier of the thermal management valve assembly.

12. The traction battery pack as recited in claim 1, wherein the ladder frame includes an integrally formed fastener housing, and comprising a fastener insert received within the integrally formed fastener housing.

13. The traction battery pack as recited in claim 1, comprising a pultruded reinforcement beam attached to the ladder frame.

14. A traction battery pack, comprising:
a cross-member assembly; and
a thermal management valve assembly mounted to the cross-member assembly and including an upper attachment frame, a lower attachment frame, and a plurality of thermal barriers that extend between the upper attachment frame and the lower attachment frame.

15. The traction battery pack as recited in claim 14, wherein the cross-member assembly includes a ladder frame, a first reinforcement beam that establishes a first pultrusion of the cross-member assembly, and a second reinforcement beam that establishes a second pultrusion of the cross-member assembly.

16. The traction battery pack as recited in claim 15, wherein the upper attachment frame is mounted at an upper section of the ladder frame, and the lower attachment frame is mounted at a lower section of the ladder frame.

17. The traction battery pack as recited in claim 15, wherein a first thermal barrier of the plurality of thermal barriers is pivotable between a first position that covers a vent opening of the ladder frame and a second position that at least partially uncovers the vent opening in response to a flow of a battery cell vent byproduct against the first thermal barrier.

18. The traction battery pack as recited in claim 15, wherein a first thermal barrier of the thermal management valve assembly includes a perforated section that is configured to rupture in response to a flow of a battery cell vent byproduct against the first thermal barrier.

19. The traction battery pack as recited in claim 14, comprising a first pushpin that mounts a first thermal barrier of the plurality of thermal barriers to the upper attachment frame, and a second pushpin that mounts the first thermal barrier to the lower attachment frame.

20. The traction battery pack as recited in claim 14, wherein the thermal management valve assembly includes a sealing frame that is arranged to seal a seam between a first thermal barrier and a second thermal barrier of the plurality of thermal barriers.
